(19) United States
(12) Patent Application Publication
(10) Pub. No.: US 2011/0139563 A1
(43) Pub. Date: Jun. 16, 2011

(54) METHOD OF OPERATING A TRIPLE-CLUTCH TRANSMISSION

(76) Inventor: Myungkoo KANG, Busan (KR)

(21) Appl. No.: 12/783,302

(22) Filed: May 19, 2010

(30) Foreign Application Priority Data
Dec. 14, 2009 (KR) 10-2009-0123811

(51) Int. Cl. B60W 10/02; B60W 30/18

(52) U.S. Cl. 192/3.54

(57) ABSTRACT

Disclosed herein is a method of operating a triple-clutch transmission. The transmission includes a main clutch and first and second clutches. The method includes shifting to first gear in such a way that the main clutch enters an engaged state while the first clutch is in a pre-engaged state and a second clutch is in a disengaged state. The method further includes shifting to second or higher gear in such a way that the main clutch maintains the engaged state and the first clutch and the second clutch alternately enter an engaged state and a disengaged state. The method further includes shifting to reverse gear in such a way that the main clutch enters the engaged state from the disengaged state while the second clutch is in a pre-engaged state and the first clutch is in the disengaged state.

### BACKGROUND OF THE INVENTION

1. Field of the Invention

The present invention relates generally to operating mechanism of a triple-clutch transmission and, more particularly, to a method of operating a triple-clutch transmission in which three front gears are provided ahead of double clutches which are provided respectively on two layshafts parallel to each other and a main clutch having high maximum allowed torque is provided ahead of the front gears, so that the minimum required size of the clutches can be reduced despite taking advantage of a conventional dual clutch in that the time required to shift gears is reduced, thus solving the problem of a size discrepancy between the gear box and the clutches and also increasing the maximum allowed torque of the clutch so that it can be used in large vehicles, such as buses, etc., and improving the energy efficiency compared to that of a wet multi-plate dual-clutch structure, and reliably preventing sudden acceleration.

2. Description of the Related Art

Dual-clutch transmissions include two clutches which are disposed at the front and are alternately operated in succession, thus reducing the time required to shift gears. Such a dual-clutch transmission is an improvement over automated manual transmissions. Taking advantage of the high economic efficiency of a manual transmission, the dual-clutch transmission reduces power loss. Furthermore, a sport-oriented driving experience is made possible thanks to rapid gear shifting. Thus, the dual-clutch transmission has recently gained popularity.

FIG. 1 is a view showing the construction of a representative example of a conventional dual-clutch transmission. The term “dual-clutch transmission (DCT)” is used to mean that the DCT is characterized in that there are two clutches C1 and C2 unlike in manual transmissions (MT) or automated manual transmissions (AMT). With reference to the drawing showing a DSG (PDK) of Volkswagen, Inc., the two clutches C1 and C2 respectively govern power transmission of odd-numbered speed gears D1, D3 and D5 and even-numbered speed gears D2, D4 and D6. Furthermore, when any gear ratio is selected, gears corresponding to the gear ratios adjacent to the selected gear ratio enter a pre-select state in which it is previously connected to an input shaft IS1 or IS2 of the engine. For instance, when the first speed gear D1 for a first gear ratio is selected, the first clutch C1 which governs the odd-numbered gears are engaged to transmit power, and the second speed gear D2 is also rotated along with the first speed gear D1. However, because the second clutch C2 which governs the even-numbered gears is in the disengaged state, power is not transmitted through the second speed gear D2 although the second speed gear D2 is rotating. When shifting from first to second gear, the first clutch C1 is disengaged and the second clutch C2 is simultaneously engaged so that the second speed gear D2 enters the engaged state. As such, every time shifting gears, connection of one clutch for transmission of power and disconnection of the other clutch for interruption of power are conducted at almost the same time. Thus, the time required for shifting is reduced. In addition, a shift shock occurring when one clutch is engaged is offset against a shift shock occurring when the other clutch is disengaged, so that the entire shift shock is markedly reduced.

However, the conventional DCT taking these advantages has several disadvantages as follows. In detail, as shown in FIG. 1, the conventional DCT has a very complex structure, and all components thereof are densely installed in a limited space. Thus, it is very difficult to manufacture the DCT, so that it is extremely expensive to produce. Furthermore, the first input shaft IS1 is coaxially disposed in the second input shaft IS2 having a hollow funnel shape. However, this structure is unsafe. In other words, if impurities are interposed between the two input shafts IS1 and IS2 which are rotating at high speed, the second input shaft IS2 may be easily damaged, because it has a hollow structure. If the rotating shaft IS2 is damaged, e.g., broken, a major accident may result. In addition, the design and manufacture of such a double rotating shaft structure are complicated and difficult. The components are very densely arranged, thus requiring very high precision. Therefore, the production cost is extremely high. When the DCT malfunctions, it is also very difficult to repair. Furthermore, because the second input shaft IS2 has a hollow structure, the durability thereof is insufficient. Moreover, the DCT shown in the drawing has a dual shaft structure in which the first input shaft IS1 and the second input shaft IS2 are coaxial so as to reduce the entire volume of the transmission. However, two output shafts must be disposed parallel to each other at upper and lower positions. Thus, a reduction in volume of the transmission is limited.

In addition, a small wet multi-plate clutch is used as each of the dual clutches C1 and C2 to reduce the entire volume of the transmission. However, because the wet multi-plate clutch uses oil to cool the clutch, power loss is unavoidable. In the small wet multi-plate clutch, it is limited to increase the maximum allowed torque of the clutch. Moreover, in the case of a first gear ratio or reverse gear ratio at which the vehicle begins to move from a stationary state, relatively high torque is required. Because of this, the DCT is designed such that the first clutch C1 which engages with the first gear or the reverse gear is larger than the second clutch C2. Such a difference in size between the clutches causes hydraulic pressure loss, thus reducing the efficiency of the DCT. Furthermore, due to a low capacity of the small wet multi-plate clutch, the conventional DCT cannot be used in a large vehicle, such as a bus or truck, in which the maximum allowed torque of the clutch is very high.

FIG. 2 is a view showing the construction of another example of a conventional dual clutch transmission, which was proposed in Japanese Patent Laid-open Publication No. Heisei. 10-26189, entitled “Underload transmission gear unit with double clutch for agricultural tractor with or without drive clutch”. This transmission includes two drive shafts 14a and 14b which are spaced apart from each other by a predetermined distance and are parallel to each other, and three gear wheels 2, 3a and 3b which are provided on the front ends of the drive shafts 14a and 14b and engage with each other. This transmission is mainly used in agricultural tractors, which are typically used in agriculture, move at low speed rather than at high speed, and deliver high torque.

Generally, a vehicle starts in first gear from a stationary state. At this time, the weight of the vehicle is applied to the wheels of the vehicle, and frictional force is applied between the wheels and the ground in the direction opposite to the direction in which the vehicle moves. Since static friction is larger than kinetic friction, the largest amount of friction force is applied to the vehicle when it in first gear. Therefore, the size of a clutch which is coupled to the first gear must be increased. In other words, the minimum required size of the clutch must be increased to overwhelm the amount of static friction. However, in the dual clutch of No. 10-26189, a small wet multi-plate clutch is also used as each of a first clutch 8a and a second clutch 8b due to the structural characteristics of the dual clutch. Thus, the dual clutch of No. 10-26189 still has the problems of the small wet multi-plate clutch structure of FIG. 1.

Therefore, an improved transmission and method of operating the transmission which solve the discrepancy between the minimum required size of the clutch and the size of the gearbox so that the maximum allowed torque is increased without increasing the size of the gearbox, and which solves the size discrepancy between first and second clutches and thus increase energy efficiency, despite taking advantage of the rapid and convenient gear shifting of the conventional dual clutch, is required.

### SUMMARY OF THE INVENTION

Accordingly, the present invention has been made keeping in mind the above problems occurring in the prior art, and an object of the present invention is to provide a method of operating a triple-clutch transmission for vehicles which can enhance the efficiency of power transmission, has a simple structure and thus is able to reduce the production cost and the repair or maintenance cost, facilitates the design of a gear ratio, and reduces the minimum required size of a clutch so that the volume of a gearbox can be minimized.

Another object of the present invention is to provide a method of operating the triple-clutch transmission in which a main clutch having a high maximum allowed torque is provided ahead of two clutches and is operated in conjunction with the two rear clutches, thus providing a trip-clutch structure which can be used in a large vehicle, such as a bus, a truck, etc., and which solves the problem of the low energy efficiency of hydraulic clutches, thus enhancing fuel efficiency, and which is configured such that the main clutch can rapidly control transmission of power, thus preventing a recent problem of rapid acceleration.

In order to accomplish the above object, the present invention provides a method of operating a triple-clutch transmission, including a main clutch provided on an input shaft coupled to a flywheel, first and second layshafts coupled to the input shaft through three front gears, and first and second clutches respectively provided on the first and second layshafts, the method including: shifting to first gear from a stationary state to transmit power to a first speed gear in such a way that the main clutch enters an engaged state from a disengaged state while the first clutch is in a pre-engaged state and a second clutch is in a disengaged state; shifting to second or higher gear transmit the power to a second or higher speed gear in such a way that the main clutch maintains the engaged state and the first clutch and the second clutch alternately enter an engaged state and a disengaged state; and shifting to reverse gear from the stationary state to transmit the power to a reverse gear in such a way that the main clutch enters the engaged state from the disengaged state while the second clutch is in a pre-engaged state and the first clutch is in the disengaged state.

The speed gears related to odd-numbered gear ratios and synchromeshes may be provided on the first layshaft, and the speed gears related to even-numbered gear ratios and synchromeshes may be provided on the second layshaft, whereby the speed gears related to the odd-numbered gear ratios and the speed gears related to the even-numbered gear ratios may be alternately selected by the synchromeshes to increase or decrease the gear ratio.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the construction of a representative example of a conventional dual clutch transmission;

FIG. 2 is a view showing the construction of another example of a conventional dual clutch transmission;

FIG. 3 is a schematic view showing the construction of a triple-clutch transmission, according to an embodiment of the present invention;

FIG. 4 is a view illustrating power transmission of the triple-clutch transmission of FIG. 3 when in first gear;

FIG. 5 is a view illustrating power transmission of the triple-clutch transmission of FIG. 3 when in second gear; and

FIG. 6 is a view illustrating power transmission of the triple-clutch transmission of FIG. 3 when in reverse gear.

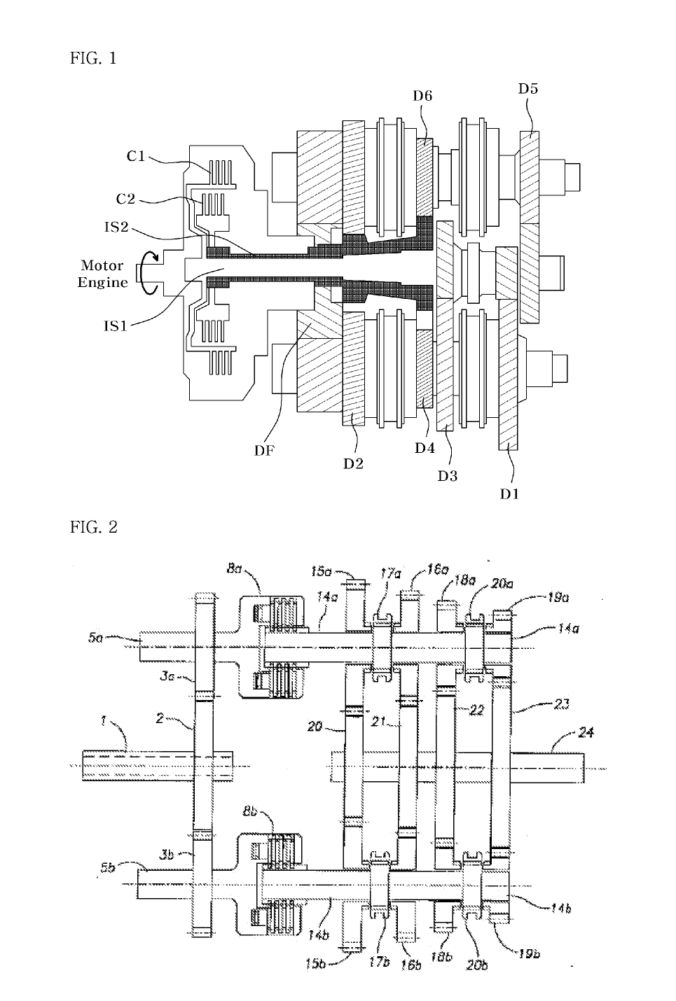

### DESCRIPTION OF THE PREFERRED EMBODIMENTS

Hereinafter, an embodiment of the present invention will be described in detail with reference to the attached drawings.

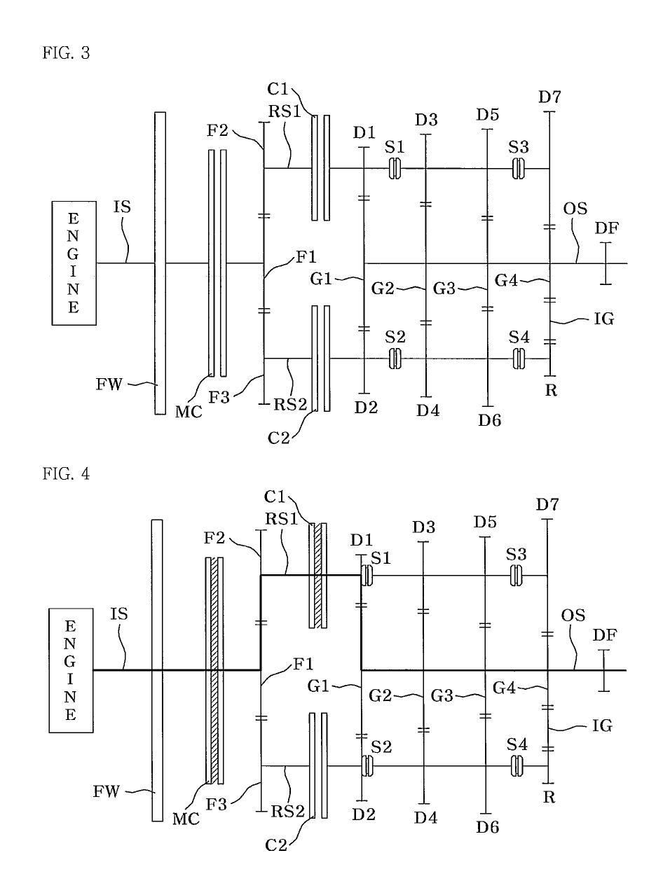

FIG. 3 is a schematic view showing the construction of a triple-clutch transmission (TCT), according to the embodiment of the present invention. The TCT of the present invention has three clutches. In detail, as shown in FIG. 3, the TCT includes an input shaft (an engine shaft) IS, first, second and third front gears F1, F2 and F3, a main clutch MC, first and second layshafts RS1 and RS2, first and second clutches C1 and C2, first, second, third, fourth, fifth, sixth and seventh speed gears (drive gears) D1, D2, D3, D4, D5, D6 and D7, a reverse gear R, driven gears (output gears) G1, G2, G3 and G4 and a single output shaft OS. In the drawing, reference character FW denotes a flywheel.

The input shaft IS is also called an engine shaft. Rotational force is transmitted from an engine to the input shaft IS.

The first and second layshafts RS1 and RS2 are arranged such that the center axes thereof are misaligned with the center axis of the input shaft IS. The first and second layshafts RS1 and RS2 are parallel to each other.

The single output shaft OS is provided between the parallel first and second layshafts RS1 and RS2 such that the output shaft OS is also parallel to the first and second layshafts RS1 and RS2. The output shaft OS may be positioned relative to the input shaft IS such that the rotating center axis thereof is aligned with that of the input shaft IS. Alternatively, the rotating center axis of the output shaft OS may be eccentric with respect to that of the input shaft IS.

The first, third, fifth and seventh speed gears D1, D3, D5 and D7 which are related to odd-numbered gear ratios are arranged in order on the first layshaft RS1 in order. The second, fourth and sixth speed gears D2, D4 and D6 which are related to even-numbered gear ratios and the reverse gear R which is related to a reverse gear ratio are arranged in order on the second layshaft RS2.

The main clutch MC controls connection or disconnection of power transmitted from the engine to the first or second layshaft RS1 or RS2.

The first and second clutches C1 and C2 are operated in conjunction with the main clutch MC and respectively selectively transmit rotational force (torque and rotational speed) of the input shaft IS to the first layshaft RS1 and the second layshaft RS2. In other words, when the main clutch MC is in an engaged state, if the first clutch C1 is engaged, the rotational force of the input shaft IS is transmitted to the first layshaft RS1. In this case, the second clutch C2 is maintained in an disengaged state. If the second clutch C2 is engaged while the main clutch MC is in the engaged state, the rotational force of the input shaft IS is transmitted to the second layshaft RS2, and the first clutch C1 enters a disengaged state.

The output shaft OS is connected to a differential gear DF to transmit the rotational force of the input shaft IS to the wheels via the transmission.

Synchromeshes S1, S2, S3 and S4 are slidably provided on corresponding shafts provided between the speed gears D1, D3, D5 and D7. The synchromeshes S1, S2, S3 and S4 are selectively coupled to the corresponding speed gears D1, D3, D5 and D7 to control transmission of power. Furthermore, the synchromeshes S1, S2, S3 and S4 are connected to a separate actuator (not shown) and controlled by an electronic control unit. A wet multi-plate clutch is used as each of the first and second clutches C1 and C2. As necessary, a dry multi-plate clutch may be used.

FIGS. 4 through 6 are views respectively showing the power transmission of the triple-clutch transmission when in first gear, second gear and reverse gear. In the present invention, the main clutch MC governs the entire power transmission of the triple-clutch transmission. Only when the main clutch MC is in the engaged state can the first or second clutch C1 or C2 be selectively engaged or disengaged to transmit power to the corresponding speed gear D1, D2, D3, D4, D5, D6, D7 or R depending on a selected gear ratio.

As shown in FIG. 4, when in first gear, the rotational force of the engine 200 is transmitted to the first layshaft RS1 via the input shaft IS and the main clutch MC. In this case, the first clutch C1 is engaged, and the second clutch C2 is disengaged. In addition, the first synchromesh S1 is connected to the first speed gear D1 so that the rotational force is transmitted to the first speed gear D1. Because the first speed gear D1 engages with the first driven gear G1, the power (rotational force) of the engine is transmitted to the differential gear DF through the first driven gear G1 and the output shaft OS. In this state, the second synchromesh S2 is selected beforehand and maintains the state of being engaged with the second speed gear D2 to prepare shifting to the next gear. This is called a “pre-select” state. However, although the second speed gear D2 is in the pre-select state, because the second clutch C2 which is connected to the second layshaft RS2 is in the disengaged state, the rotational force of the input shaft IS is not transmitted to the second speed gear D2. In other words, the second speed gear D2 maintains an idle state. In the drawings, the thick solid line denotes a power transmission path.

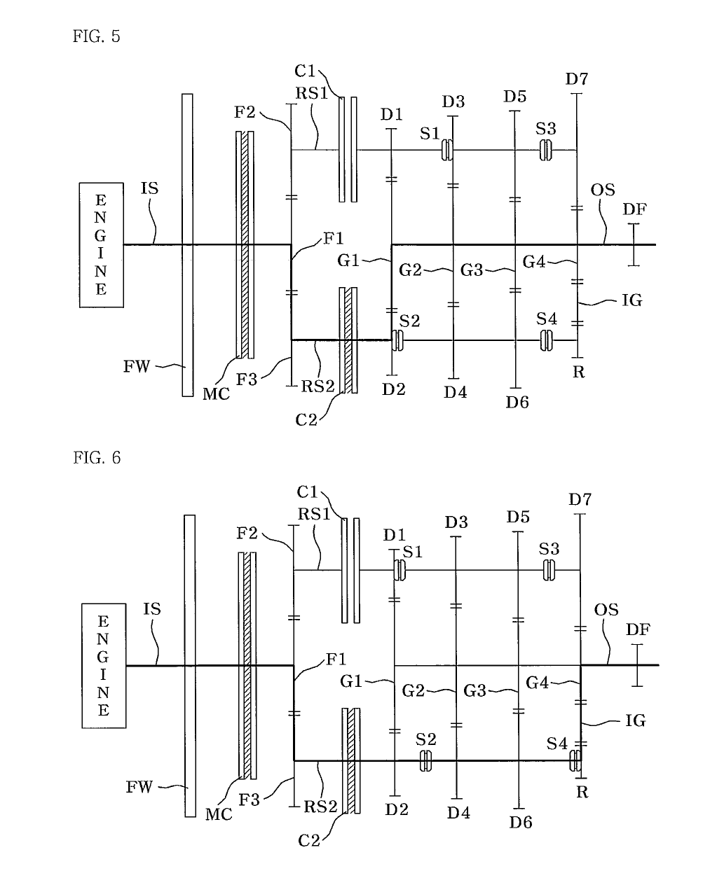

As shown in FIG. 5, when in second gear, the first clutch C1 enters the disengaged state and the second clutch C2 enters the engaged state. Here, because the second speed gear D2 has been in the pre-select state, the second speed gear D2 receives the rotational force and transmits it to the first driven gear G1 to rotate the output shaft OS, as soon as the second clutch C2 enters the engaged state. In the same manner as in first gear, to prepare the next gear shifting, the first synchromesh S1 engages with the third speed gear D3 and thus enters a pre-select state.

Also, when in third through seventh gears, the first and second clutches C1 and C2 alternately enter the engaged state and the disengaged state such that power is continuously transmitted from the engine to the differential gear DF. Furthermore, during this operation, a speed gear corresponding to the next gear in relation to the current gear is previously selected and thus stands by in the pre-select state, in the same manner as that in the first and second gears. As such, gear shifting between the first through seventh gears can be rapidly conducted in succession.

As shown in FIG. 6, when in reverse gear, the fourth synchromesh S4 engages with the reverse gear R, so that the rotational force is transmitted to the fourth driven gear G4 through an idling gear IG.

Ordinarily, in first gear or reverse gear, relatively high torque is required, because the vehicle which has been in the stationary state begins to move. Therefore, the minimum size of the clutch required to rotate the wheels while overcoming static friction force without slipping has been predefined. The minimum size of the clutch increases as the size of the vehicle increases. For example, in the case of a bus or truck, a comparatively very high torque is required. Thus, the dry clutch is mainly used, rather than the wet multi-plate clutch, because the diameter of the dry clutch is larger than that of the wet multi-plate clutch, resulting in an enhanced frictional effect and a reduction in power loss. Furthermore, in the case of a small passenger car, the wet multi-plate clutch may be used, but it is preferable that the size of a clutch related to first gear be relatively large to ensure sufficient torque. In particular, when the vehicle starts on an upward slope, torque required when starting in first gear or the minimum required size of the clutch is further increased. Because of this, in the conventional dual clutch transmission, the first and second clutches are designed such that the size of the first clutch connected to the first speed gear is larger than that of the second clutch. However, in the small wet multi-plate clutch used in the conventional dual clutch transmission, although the size of the first clutch is increased to its largest size, it is restricted due to the structural characteristics of the dual clutch. Therefore, the conventional dual clutch transmission cannot be used in large vehicles, e.g., a large bus or truck, which has a relatively very high maximum allowed torque. In addition, in the conventional technique, because of the size discrepancy between the first and second clutches which are wet multi-plate clutches, energy loss results when operating the hydraulic actuator.

In the present invention, to solve these problems of the conventional dual cutch transmission, the first and second clutches CS1 and CS2 which comprise relatively small wet multi-plate clutches are combined with the main clutch MC which comprises a relatively large dry clutch. The main clutch MC which is a dry clutch is provided on the input shaft IS which is disposed ahead of the three front gears F1, F2 and F3. Thus, the size of the main clutch MC can be increased to increase the maximum allowed torque, regardless of the volume of a gearbox of the transmission. Furthermore, the main clutch MC which comprises a dry clutch is operated using an electric motor rather than using a hydraulic actuator, thus preventing an energy loss, unlike a wet clutch the hydraulic operation of which causes an energy loss.

Moreover, in the present invention, even though the case of the vehicle starting motion either in the forwards or rearwards direction from the stationary state is taken into account, in other words, even though the case where a relatively high maximum allowed torque of the clutch is required is taken into account, because the main clutch MC which can have a relatively very large size governs the power connection, the first and second clutches C1 and C2 which comprise wet multi-plate clutches can have relatively small sizes and may be of the same size. Therefore, the present invention can prevent hydraulic energy loss of the actuator attributable to the size increase of the wet multi-plate clutches or the size discrepancy therebetween, thereby enhancing fuel efficiency.

As such, the main clutch MC is larger than the first or second clutch C1 or C2. When the components of the triple-clutch transmission are arranged from large to small, they can be arranged in a sequence of the flywheel FW, the main clutch MC and the first or second clutch C1 or C2.

The operation of the triple-clutch transmission of the present invention will be explained below.

In order that the vehicle starts in first gear (D1) from the stationary state, the first clutch C1 which can have a relatively small size is in the engaged state and the second clutch C2 is in the disengaged state. From this state, the gear is shifted to first gear and the main clutch MC which has been in the disengaged state is simultaneously engaged. Thus, power is transmitted from the engine to the first layshaft RS1. Thereby, the rotational force is transmitted to the output shaft OS through the first speed gear D1.

When shifting to second or higher gear, the main clutch MC maintains the engaged state, and only the first and second clutches C1 and C2 alternately enter the engaged state and the disengaged state.

In the operation of shifting to reverse gear, the second clutch C2 is in the engaged state and the first clutch C1 is in the disengaged state. Furthermore, when shifting to reverse gear, the main clutch MC which has been in the disengaged state enters the engaged state so that the power connection is made. At this time, because only the second clutch C2 is in the engaged state, the rotational force of the input shaft IS is directly transmitted to the second layshaft RS2 and then transmitted to the output shaft OS through the reverse gear R.

As such, in the present invention, when a relatively high torque is required due to high friction, for example, when the vehicle starts forwards or rearwards from the stationary state, the main clutch MC which has a relatively large size conducts the function of connecting or disconnecting power. When gear shifting is required after the vehicle begins to move, the first and second clutches C1 and C2 which may have relatively small sizes can rapidly conduct the gear shifting.

Moreover, in the present invention, even though the size of the main clutch MC is largely increased, the volume of the gear box remains the same. Hence, the present invention can be effectively used even in large vehicles, such as buses or trucks, which mainly use a relatively very large dry clutch. Furthermore, the triple-clutch transmission of the present invention may be configured such that the main clutch MC has a dry clutch structure suitable to coping with high torque and the first and second clutches C1 and C2 are wet multi-plate clutch structures.

The method of operating the triple-clutch transmission of the present invention will be compared with the mechanism of the conventional dual-clutch transmission, focusing on differences therebetween.

The conventional dual-clutch transmission and the triple-clutch transmission of the present invention have in common the fact that both conduct gear shifting in such a way that the two wet multi-plate clutches which are controlled by hydraulic actuators alternately enter the engaged state and the disengaged state; however, when a vehicle is in the stationary state or the neutral gear state which is an idling state, their operating mechanisms differ. In this state, in the case of the conventional dual-clutch transmission, both the first and second clutches are in the disengaged state. Thereafter, the vehicle begins to move forwards the moment the first clutch enters the engaged state. On the other hand, in the triple-clutch transmission, even when the vehicle is in the stationary state or the neutral gear state, the first clutch C1 is in the engaged state while the main clutch MC is in the disengaged state. Of course, the second clutch C2 is in the disengaged state. Thereafter, when the main clutch MC which has been in the disengaged state enters the engaged state, power is transmitted to the first speed gear through the first clutch C1 which has already been in the engaged state. Thus, the vehicle can rapidly begin to move forwards. As such, in the triple-clutch structure, either of the first or second clutch C1 or C2 is certainly in the engaged state all the time while the vehicle is operated. However, in the conventional dual-clutch structure, there occurs a period of time when both the two clutches are in the disengaged state. Furthermore, because the two clutches are independently controlled by the two hydraulic actuators, if a TCU or ECU malfunctions, the two clutches may be undesirably in the engaged state at the same time. In this case, the gearbox of the transmission may be damaged and result in a major accident. However, in the triple-clutch structure of the present invention, the first and second clutches C1 and C2 are operated depending on the main clutch MC. Thus, even if the TCU or ECU malfunctions, the two clutches C1 and C2 are fundamentally prevented from entering the engaged state at the same time, thus ensuring very superior safety compared to the conventional dual-clutch structure.

The enhanced safety of the triple-clutch structure of the present invention confers an advantage of preventing sudden acceleration of the vehicle. In detail, the triple-clutch transmission of the present invention may be constructed such that when a driver steps hard on the brake, the main clutch MC is disengaged to interrupt power transmission. Therefore, even if sudden acceleration of the vehicle occurs attributable to malfunction of the TCU or ECU, the vehicle can be prevented from abnormally moving only by stepping on the brake. In the case of the conventional dual-clutch transmission, the mechanical coupling between the brake and the wet multi-plate first and second clutches is very complex due to structural characteristics. That is, in the operating mechanism of the conventional dual-clutch transmission, when the brake is operated to reduce the speed of the vehicle or stop the vehicle while the first and second clutches are independently operated, the ECU reduces the rpm of the engine and disengages the first and second clutches. On the other hand, in the triple-clutch structure, the main clutch MC is operated by the electric motor. Accordingly, the present invention can easily realize the structure such that when the driver steps hard on the brake, the main clutch MC is disengaged. Thus, in the present invention, even if the vehicle should suddenly accelerate, the main clutch MC can be easily disengaged only by stepping hard on the brake and the power transmission is directly interrupted. As such, the triple-clutch structure of the present invention can guarantee safety even under the condition of sudden acceleration. Furthermore, a separate clutch pedal which interrupts the power transmission of the main clutch MC may be provided such that interruption of power transmission can be realized without using the brake pedal.

In the embodiment, although the transmission has been illustrated as having a total of eight gear ratios including reverse gear, the number of gear ratios is not limited thereto and may be varied as necessary.

As described above, in a triple-clutch transmission according to the present invention, a main clutch having a relatively high maximum allowed torque is provided ahead of the first and second clutches, so that the minimum required sizes of the first and second clutches can be reduced. Because the main clutch has a size sufficient to provide the maximum allowed torque which can be applied to the low gear of large vehicles, such as buses or trucks, the width of the gearbox can be satisfactorily reduced.

Furthermore, the first and second clutches which are wet multi-plate clutches can be of the same size. Hence, the present invention can solve the conventional problem of the energy loss of a hydraulic actuator attributable to the size discrepancy between the first and second clutches, thereby enhancing fuel efficiency.

In addition, because the dry large clutch which can be rapidly and efficiently operated by an electronic motor is provided ahead of the first and second clutches which are small wet clutches, the power can be rapidly interrupted when necessary. Therefore, the present invention can safely cope with the problem of rapid acceleration.

Moreover, the present invention can avoid the problem of engine stop which is frequently induced by the conventional dual clutch structure.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method of operating a triple-clutch transmission comprising: a main clutch provided on an input shaft coupled to a flywheel; first and second layshafts coupled to the input shaft through three front gears; and first and second clutches respectively provided on the first and second layshafts, the method comprising:
shifting to first gear from a stationary state to transmit power to a first speed gear in such a way that the main clutch enters an engaged state from a disengaged state while the first clutch is in a pre-engaged state and a second clutch is in a disengaged state;
shifting to second or higher gear to transmit the power to a second or higher speed gear in such a way that the main clutch maintains the engaged state and the first clutch and the second clutch alternately enter an engaged state and a disengaged state; and
shifting to reverse gear from the stationary state to transmit the power to a reverse gear in such a way that the main clutch enters the engaged state from the disengaged state while the second clutch is in a pre-engaged state and the first clutch is in the disengaged state.

2. The method as set forth in claim 1, wherein the speed gears related to odd-numbered gear ratios and synchromeshes are provided on the first layshaft, and the speed gears related to even-numbered gear ratios and synchromeshes are provided on the second layshaft, whereby the speed gears related to the odd-numbered gear ratios and the speed gears related to the even-numbered gear ratios are alternately selected by the synchromeshes to increase or decrease the gear ratio.
